(19) United States
(12) Patent Application Publication
(10) Pub. No.: US 2015/0169740 A1
(43) Pub. Date: Jun. 18, 2015

(54) SIMILAR IMAGE RETRIEVAL

(71) Applicants: Steinar H. Gunderson, Zurich (CH); Julien Pilet, Renens VD (CH); Henrik C. Stewenius, Zurich (CH)

(72) Inventors: Steinar H. Gunderson, Zurich (CH); Julien Pilet, Renens VD (CH); Henrik C. Stewenius, Zurich (CH)

(73) Assignee: GOOGLE INC., Mountain View, CA (US)

(21) Appl. No.: 13/593,420

(22) Filed: Aug. 23, 2012

Related U.S. Application Data
(60) Provisional application No. 61/562,320, filed on Nov. 21, 2011.

(51) Int. Cl. G06F 17/30

(52) U.S. Cl. CPC G06F 17/30675

(57) ABSTRACT

Methods, systems, and apparatus, including computer programs encoded on computer storage media, for determining image search results. One of the methods includes receiving a query image. Multiple feature vectors from the query image are computed and quantized into one or more respective visual words. Multiple posting lists are identified, each posting list corresponding to a quantized visual word, each posting list identifying images that have the visual word, each identified image being associated with geometry data for the corresponding visual word. One or more matching images are identified that match the query image by before traversing the multiple posting lists more than once. While traversing the multiple posting lists, a score is computed for each matching image when identified as a matching image and before traversal of the multiple posting lists is complete.

### CROSS-REFERENCE TO RELATED APPLICATIONS

This application claims the benefit under 35 U.S.C. §119(e) of the filing date of U.S. Provisional Patent Application No. 61/562,320, for SIMILAR IMAGE RETRIEVAL, which was filed on Nov. 21, 2011, and which is incorporated here by reference.

### BACKGROUND

This specification relates to information retrieval.

Conventional information retrieval systems are used to identify a wide variety of resources, for example, images, audio files, web pages, or documents, e.g., news articles. Additionally, search results presented to a user that identify particular resources responsive to a query are typically ranked according to particular criteria.

### SUMMARY

Image search systems can assign visual words to images, and in this context, images may be said to have visual words. Image search systems can identify features of images and compute a feature vector for each identified feature. Image search systems can quantize each computed feature vector into one or more corresponding visual words. Image search systems can identify images that are visually similar to a query image by identifying images having one or more visual words in common with the query image. After identifying a particular image as having one or more visual words in common with a query image, the search system can compute a score that indicates a measure of visual similarity between the particular image and the query image.

To enable image search systems to identify images having one or more visual words in common with a query image, the systems can index images by visual word. A posting list can be created for each visual word assigned to any image in a collection of images, in which each item on the posting list identifies a respective image having that visual word.

Certain image search systems can achieve good performance by traversing multiple image posting lists in parallel. When a same image is encountered in a threshold number of posting lists, the image is designated as a matching image, and a score is computed for the image, before traversal of the posting lists is complete.

In general, one innovative aspect of the subject matter described in this specification can be embodied in methods that include the actions of receiving a query image; computing multiple feature vectors from the query image and quantizing each feature vector into one or more respective visual words; identifying multiple posting lists, each posting list corresponding to one of the respective quantized visual words, each posting list identifying images that have the visual word, each identified image being associated with geometry data for the corresponding visual word; identifying one or more matching images that match the query image before traversing the multiple posting lists more than once; and while traversing the multiple posting lists, computing a score for each matching image when identified as a matching image and before traversal of the multiple posting lists is complete, wherein a score for an image is based at least in part on geometry data associated with matching visual words. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Identifying a matching image comprises identifying an image occurring on a number of the identified posting lists that satisfies a threshold. Computing a score for each matching image comprises computing a score for each matching image before further traversing any of the identified posting lists. Traversing the multiple posting lists comprises maintaining a tree structure, wherein each leaf node of the tree structure corresponds to a posting list being traversed and includes a document identifier of an item on the corresponding posting list, wherein items on each posting list are sorted by document identifier, wherein each parent node of the tree structure includes (1) a least-advanced child identifier of child nodes descendent from the parent node (2) a count of leaf nodes descendent from the parent node that include the least-advanced child identifier, and (3) a list identifier of a posting list that includes the least-advanced child identifier, wherein identifying a matching image comprises identifying a document identifier in a root node of the tree structure when a count of leaf nodes in the root node satisfies a threshold; and advancing a posting list whose list identifier is in the root node of the tree structure. Advancing a posting list comprises updating a leaf node corresponding to the posting list from a first document identifier to a second subsequent document identifier; updating parent nodes of the updated leaf node including updating least-advanced child identifiers of parent nodes of the updated leaf node; updating counts of leaf nodes that include the least-advanced child identifier of parent nodes of the updated leaf node; and updating list identifiers of posting lists that include the least-advanced child identifier of parent nodes of the updated leaf node. The actions include weighting each first score by a weight based on a computed feature space density of a feature cell for the corresponding visual word. Updating parent nodes of the updated leaf node comprises updating parent nodes using at least one conditional move instruction. Updating one of the parent nodes using at least one conditional move instruction comprises generating a sum node with elements of a child node of two or more child nodes of the parent node being updated, wherein a count element of the sum node is a sum of count elements of the two or more child nodes of the parent node that is being updated; determining that the document identifier of a first child node of the two or more child nodes is less than a document identifier of a second child node of the two or more child nodes; and moving, using the conditional move instruction, the contents of the first child node into the parent node. Updating one of the parent nodes using at least one conditional move instruction comprises generating a sum node with elements of a child node of two or more child nodes of the parent node being updated, wherein a count element of the sum node is a sum of count elements of the two or more child nodes of the parent node that is being updated; determining whether the document identifier of a first child node of the two or more child nodes is equal to a document identifier of a second child node of the one or more child nodes; and moving, using the conditional move instruction, the contents of the sum node into the parent node. The actions include computing the feature space density of the feature cell including quantizing each of a plurality of feature vectors into a corresponding feature cell; and computing a size of each feature cell, wherein the feature space density is based at least in part on dividing a number of feature vectors of the feature cell by the computed size of the feature cell. Computing a score for each matching image comprises computing a first score for each matching visual word between the query image and the matching image based on a geometric mapping between visual words of the query image and visual words of the matching image.

In general, another innovative aspect of the subject matter described in this specification can be embodied in methods that include the actions of receiving a query image; computing multiple feature vectors from the query image and quantizing each feature vector into one or more respective visual words; identifying multiple posting lists, one posting list for each computed visual word, wherein each posting list is a list of document identifiers for respective images that are assigned a same visual word, wherein each of the multiple posting lists is associated with a respective cursor, wherein each cursor identifies an item on the corresponding posting list, wherein each item on the posting list includes geometry data for the visual word; traversing the multiple posting lists by repeatedly: selecting one of the cursors as the current cursor; advancing a posting list of the current cursor by updating the cursor to a subsequent item on the posting list of the current cursor; determining whether a threshold number of cursors identify a same document identifier; computing a score for the image corresponding to the same document identifier if a threshold number of cursors identify the same document identifier, wherein the score is based at least in part on the geometry data included in posting list items identified by the cursors; and ranking the images by computed score, wherein scores are computed for multiple images before traversal of the multiple posting lists is complete. Other embodiments of this aspect include corresponding computer systems, apparatus, and computer programs recorded on one or more computer storage devices, each configured to perform the actions of the methods.

In general, another innovative aspect of the subject matter described in this specification can be embodied in methods that include the actions for traversing multiple posting lists in parallel including maintaining a tree structure, wherein each leaf node of the tree structure corresponds to a posting list being traversed and includes a document identifier of an item on the corresponding posting list, wherein items on each posting list are sorted by document identifier, wherein each parent node of the tree structure includes (1) a least-advanced child identifier of child nodes descendent from the parent node (2) a count of leaf nodes descendent from the parent node that include the least-advanced child identifier, and (3) a list identifier of a posting list that includes the least-advanced child identifier; designating as a match a document identifier in a root node of the tree structure when a count of leaf nodes in the root node satisfies a threshold; and advancing a posting list whose list identifier is in the root node of the tree structure. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. Advancing a posting list comprises updating a leaf node corresponding to the posting list from a first document identifier to a second subsequent document identifier; updating parent nodes of the updated leaf node including updating least-advanced child identifiers of parent nodes of the updated leaf node; updating counts of leaf nodes that include the least-advanced child identifier of parent nodes of the updated leaf node; and updating list identifiers of posting lists that include the least-advanced child identifier of parent nodes of the updated leaf node. Updating parent nodes of the updated leaf node comprises updating parent nodes using at least one conditional move instruction. Updating one of the parent nodes using at least one conditional move instruction comprises generating a sum node with elements of a child node of two or more child nodes of the parent node being updated, wherein a count element of the sum node is a sum of count elements of the two or more child nodes of the parent node that is being updated; determining that the document identifier of a first child node of the two or more child nodes is less than a document identifier of a second child node of the two or more child nodes; and moving, using the conditional move instruction, the contents of the first child node into the parent node. Updating one of the parent nodes using at least one conditional move instruction comprises generating a sum node with elements of a child node of two or more child nodes of the parent node being updated, wherein a count element of the sum node is a sum of count elements of the two or more child nodes of the parent node that is being updated; determining that the document identifier of a first child node of the two or more child nodes is equal to a document identifier of a second child node of the two or more child nodes; and moving, using the conditional move instruction, the contents of the sum node into the parent node.

The subject matter described in this specification can be implemented in particular embodiments so as to realize one or more of the following advantages. Traversing multiple posting lists in parallel allows geometry data to be stored in posting lists, which a system can use to compute a similarity score for all matching images, even in a very large collection of images. Traversing multiple posting lists in parallel can reduce the time required to traverse the posting lists. Using a tree structure to advance posting lists and identify matching images improves performance of an image search system. Using a computed feature cell density can improve the quality of image retrieval results and save computational resources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates inputs and outputs of an example image search system.

FIG. 2 illustrates an example image search system.

FIG. 3 is a diagram of multiple example posting lists.

FIG. 4 is a flow chart of an example process for scoring images by traversing multiple posting lists in parallel.

FIG. 5A is a diagram of an initial example tree structure that can be used for determining which of multiple posting lists to advance.

FIG. 5B is a diagram of an example tree structure after advancing an example posting list corresponding to a leaf node as shown in FIG. 5A.

FIG. 6 is a flow chart of an example process for traversing multiple posting lists using a tree structure to select which posting list to advance next.

FIG. 7 is a flow chart of an example process for computing a similarity score based on a feature cell density.

Like reference numbers and designations in the various drawings indicate like elements.

### DETAILED DESCRIPTION

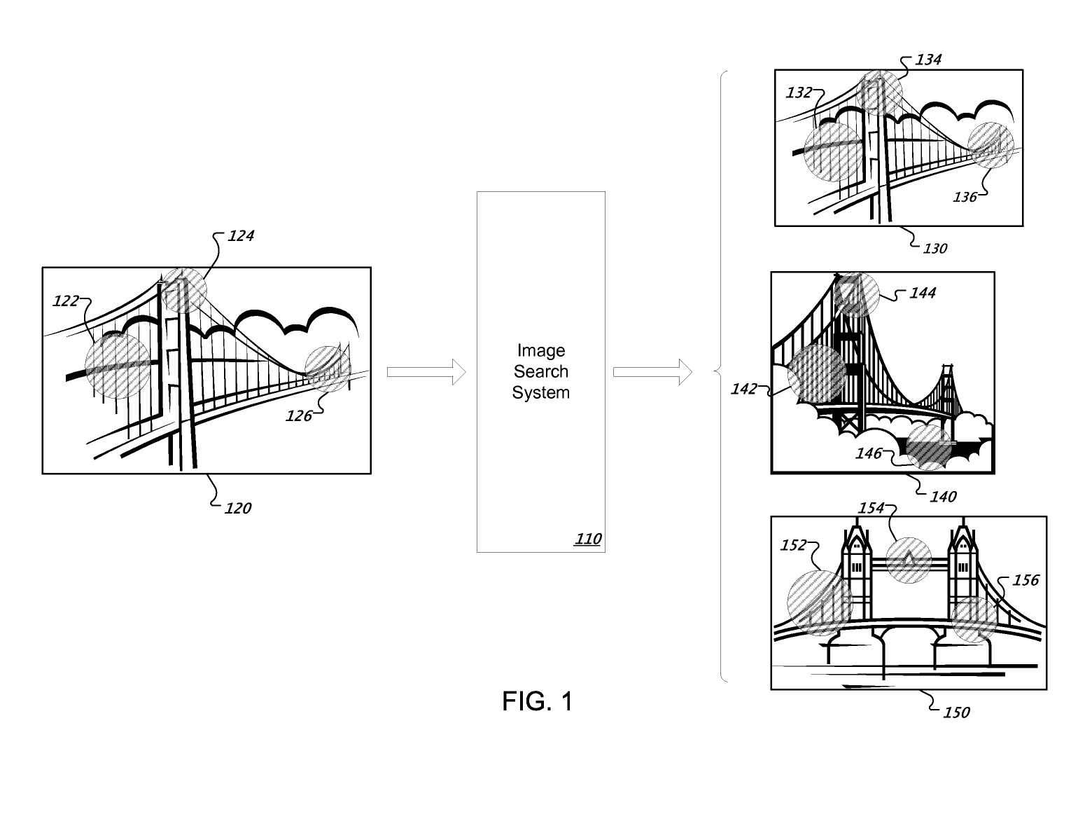

FIG. 1 illustrates the input and output of an example image search system 110. The search system 110 takes as input a query image 120 and provides as output one or more image search results, i.e. results that each identify a corresponding result image 130, 140, and 150, in response to the query image. Generally, multiple search results will be presented together in a user interface presentation, e.g., a web page, each search result will include a thumbnail of the corresponding result image that the search result identifies as well as a link, e.g., a hyperlink, to the result image. The image search system 110 can order the image search results for presentation or other purposes by a measure of visual similarity to the query image 120. Thus, the image search system 110 can identify images that are visually similar to a query image 120.

For example, the system orders the images 130, 140, and 150 by visual similarity to the query image 120. Image 130 is a resized version of image 120 and is most visually similar to the query image 120 of the three provided images. Image 140 is an image of the same bridge depicted in image 130, but from a perspective different from that of the query image 120. Therefore, the image search system 110 determines that image 140 is less similar to query image 120 than image 130. The image search system 110 similarly determines that image 140 is more similar to the query image 120 than image 150.

The image search system 110 can compute a measure of similarity between a query image and other images by using data that characterizes feature regions identified in the images. In some implementations, the search system 110 identifies elliptical regions in each image as feature regions. For example, the system 110 can identify elliptical regions 122, 124, and 126 in the query image 120 as feature regions. Similarly, the system 110 can identify feature regions in each of a plurality of images in a database, including images 130, 140, and 150. The system can, for example, identify as feature regions elliptical regions 132, 134, and 136 of image 130; 142, 144, and 146 of image 140; and 152, 154, and 156 of image 150.

The system 110 can compute a feature vector from each feature region. A feature vector can be a vector where each element of the vector is a quantity that represents a feature value of a feature of the corresponding feature region. The system 110 can compute a similarity score between two images by computing a similarity measure between feature vectors computed from each image. The system 110 can then determine that images having more similar feature vectors are more visually similar than images with less similar feature vectors. For example, the system 110 can determine that feature vectors computed from feature regions 122 and 132 have a higher similarity than feature vectors computed from feature regions 122 and 152.

To simplify the comparison of feature vectors, the search system 110 can quantize the feature space of feature vectors into a finite number of cells, which can be referred to as “visual words.” Then, for a given feature vector, the system 110 can determine to which of one or more visual words the feature vector should be assigned. The system 110 can determine to which of the cells of the feature space a particular feature vector belongs, for example, using an appropriate distance metric.

The system can then quantize each feature vector for a particular image into a corresponding visual word and assign the visual words to the particular image. The system can also associate each visual word with geometry information of the corresponding feature region. For example, the geometry information can include a position in the image, e.g. pixel coordinates, of the corresponding feature region and a scale indicating a size of the feature region.

After assigning visual words to images, the system 110 can make a preliminary determination of image similarity between two images by computing how many visual words the two images have in common. The system 110 can thus save computation resources by computing a similarity score between two images only if the two images have at least a threshold number of visual words in common.

For example, the system 110 can determine that a feature vector computed from region 122 is assigned to visual word A, that the feature vector computed from region 124 is assigned to visual word B, and that the feature vector computed from region 126 is assigned to visual word C. The system 110 can similarly determine that feature vectors from feature regions 132, 134, and 136 of image 130 are also assigned to visual words A, B, and C, and can therefore determine that query image 120 and image 130 have three visual words in common. Similarly, the system 110 can determine that feature vectors computed from image 140 are assigned to visual words A, B, and D and determine that query image 120 and image 140 have two visual words in common. The system 110 can determine that feature vectors computed from image 150 are assigned to visual words A, E, and F and determine that query image 120 and image 150 have only one visual word in common.

In some implementations, the system 110 can index images in multiple posting lists. For each visual word in the feature space, the system can maintain a posting list of images that have been assigned the visual word at least once. The system can then scan posting lists for the visual words of a query image in order to identify indexed images that have at least a threshold number of visual words in common with the query image. Posting list traversal will be described in more detail below.

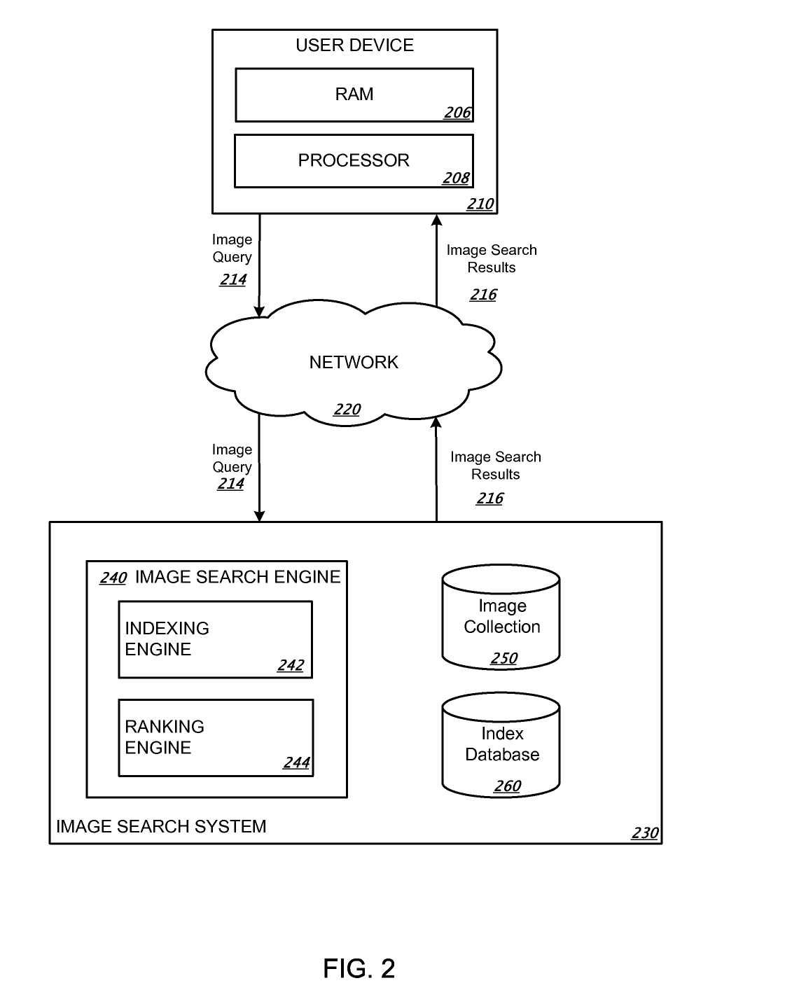

FIG. 2 illustrates an example image search system 230. The image search system 220 is an example of an information retrieval system in which the systems, components, and techniques described below can be implemented.

A user device 210 can be coupled to the image search system 230 through a data communication network 220. In general, the user device 210 transmits an image query 214 over the network 220 to the image search system 230. The image query 214 specifies a particular image, for example, by an image file or a resource locator, e.g. a uniform resource locator (URL), provided by the user device 210. The image query 214 can alternatively specify image features determined by user device 210. The image search system 230 identifies images that satisfy the image query 214 and generates image search results 216. The image search system 230 transmits the image search results 216 over the network 220 back to the user device 210 for presentation to a user. Generally, the user is a person; but in certain cases, the user can be a software agent.

The user device 210 can be any appropriate type of computing device, e.g., a server, mobile phone, tablet computer, notebook computer, music player, e-book reader, laptop or desktop computer, PDA (personal digital assistant), smart phone, or other stationary or portable device, that includes one or more processors, e.g., processor 208, for executing program instructions, and random access memory, e.g., RAM 206. The user device 210 can include computer readable media that store software applications, e.g., a web browser or a layout engine, an input device, e.g., a keyboard or mouse, a communication interface, and a display device.

The network 220 can be, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination of such networks.

The image search system 230 can be implemented as computer programs installed on one or more computers in one or more locations that are coupled to each other through a network, e.g., network 220. The image search system 230 includes a search engine 240, an image collection 250 and an index database 260. The index database 260 contains one or more indices of images in the image collection 250. The “indexed images” are images in the image collection 250 that are indexed by any of the indices in the image database 250.

When the image query 214 is received by the image search system 230, a search engine 240 identifies resources that satisfy the query 214. The image search system 230 identifies images in the image collection 250 that have a highest similarity score for an image specified by the image query 214.

The search engine 240 will generally include an indexing engine 242 that indexes images. In some implementations, the indexing engine maintains multiple posting lists in the index database 260. Each posting list is a list of images in the image collection 250 that have a same particular visual word.

The search engine 240 can identify resources that satisfy the image query 214. The search engine 240 includes a ranking engine 244 that can rank identified resources. For example, the ranking engine 244 can identify indexed images that have at least a threshold number of visual words in common with the image specified by image query 214. The ranking engine 214 can then rank the identified images, e.g. by a computed similarity score.

The image search system 230 can respond to the image query 214 by generating image search results 216, which the system can transmit over the network 220 to the user device 210 in a form that can be presented on the user device 210, e.g., in a form that can be displayed in a web browser on the user device 210. For example, the image search results 216 can be presented in a markup language document, e.g., a HyperText Markup Language or eXtensible Markup Language document. The user device 210 renders the received form of the image search results 216, e.g., by rendering a markup language document using a web browser, in order to present the image search results 216 on a display device coupled to the user device 210.

Multiple image search results 216 are generally presented at the same time; although on a small display device the results may be presented one at a time. Each of the presented image search results can include titles, text snippets, images, links, or other information. Each image search result is linked to a particular resource, e.g., Internet addressable document. Selection of an image search result, e.g., by a click, can cause a display program running on the user device 210 to request the resource associated with the image search result and display the resource when it is received.

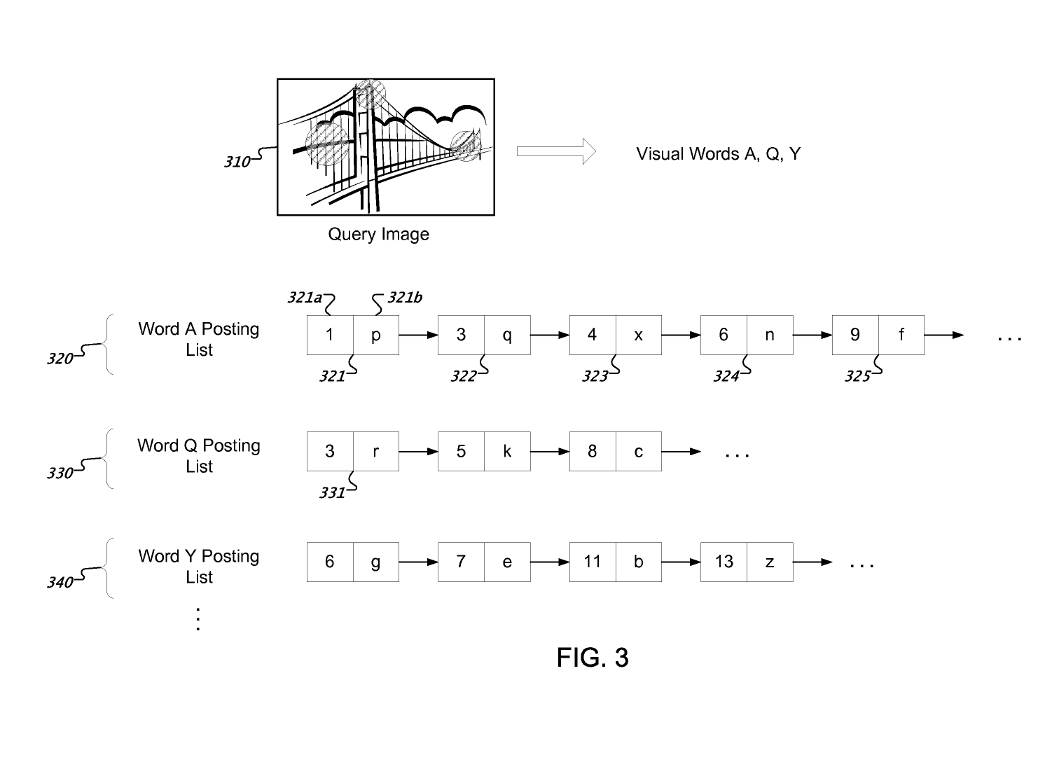

FIG. 3 is a diagram of multiple example posting lists. Each posting list shown in FIG. 3 includes a list of images, e.g., from an image collection, that have a same particular visual word.

An example query image 310 has three example visual words, A, Q, and Y. Each posting list corresponds to exactly one visual word as defined by the system, e.g. as defined by a quantizer. For example, posting list 320 is a list of images that are assigned visual word A. Posting list 330 is a list of images that are assigned visual word Q, and posting list 340 is a list of images that are assigned visual word Y.

In the posting lists, images can be identified by document identifiers. The document identifiers can be, for example, keys to a database, e.g., an index database, or file system identifiers of electronic image documents.

For example, item 321 of posting list 320 includes document identifier 321a, with a value of “1”, indicating that the image identified by document identifier “1” is an image that has visual word A. Similarly, items 322, 323, 324, and 325 of the posting list 320 include document identifiers “3”, “4”, “6”, and “9”, respectively, which indicates that corresponding images also have visual word A.

A search system can maintain the posting lists in a sorted order by document identifiers. For example, items in posting list 320 are sorted by increasing order of document identifiers, e.g., “1”, “3”, “4”, “6”, and “9”. The posting lists can equivalently be maintained in a decreasing order of document identifiers, or the posting lists can be sorted in some other way.

A search system can traverse the posting lists that correspond to visual words of the query image 310 to identify images having at least a threshold number of visual words in common with query image 310, referred to as matching images. For example, by traversing posting list 320 and posting list 330, the system can encounter an item 322 in posting list 320 and an item 331 in posting list 330, both of which have a same document identifier “3”. Therefore, the system can determine that the image identified by the document identifier “3” has at least two visual words in common with query image 310.

A search system can score an image upon determining that the image has at least a threshold number of visual words in common with a query image by traversing the multiple posting lists in parallel. In other words, the search system can compute a similarity score for the image before traversal of the posting lists is complete.

The search system can store geometry data and other data of the visual words in the posting lists to support more advanced scoring algorithms while traversing the posting list. Each posting list item for a visual word can, for example, include geometry data, e.g., a position and a scale associated with the region or regions with which the visual word is associated in the image. For example, item 321 of posting list 320 can include geometry data 321b, which can specify a position and a scale for visual word A assigned to the image identified by document identifier “1”. The value “p” of geometry data 321b shown in FIG. 3 merely illustrates that the geometry data is different from geometry data of other items in the posting lists.

The geometry data stored with the posting list items can be used to score an image as soon as the system determines that an image is a matching image having at least a threshold number of visual words in common with the query image. The system can therefore score the image before advancing other posting lists. Therefore, in some implementations, the system will have already computed similarity scores for all matching images by the time traversal of the posting lists is complete. In addition, because the geometry data is stored with the posting list items, the system can compute a similarity score without having to fetch additional data.

The computed similarity score can be based on a measure of how well the visual words of the query image align with matched visual words of the matching image under a particular geometric mapping. The system can define a variety of geometric mappings, including translation, scaling, rotation, skewing, in addition to other transformations.

The geometric mapping transforms coordinates of visual words from the query image into transformed coordinates. Matched visual words of the matching image can be said to align with visual words of the query image if the coordinates of the matched visual words are close to the respective transformed coordinates or within a certain error threshold. Thus, visual words that are more closely aligned will result in a higher score than visual words that are less closely aligned.

In some implementations, the system searches for a geometric mapping that is of the form:

f(x,y)=[ax+b,cy+d],

where (x, y) are coordinates of visual words in the query image, and [ax+b, cy+d] are transformed coordinates. In other words, each x coordinate of each visual word of the query image has a corresponding transformed coordinate computed by ax+b. Similarly, each y coordinate of each visual word of the query image has a corresponding transformed coordinate computed by cy+d. The system can thus determine a particular geometric mapping by determining values for a, b, c, and d that optimize the alignment between the visual words of the query image and the visual words of a matching image. In some implementations, the system uses a Random Sample Consensus (RANSAC) algorithm to determine values for a, b, c, and d.

The system can compute a distance between coordinates of each matched visual word and each corresponding set of transformed coordinates. For each visual word in which the distance is within a particular error threshold, e.g. 0.5, 50, or 2000, the system can increase the similarity score for the image by a particular amount, e.g., 1, 100, or 10,000. For example, the system can assign a point value to each aligned visual word of a matched image. If three out of four matched visual words align with visual words of the query image, the matched image can be assigned a similarity score based on the third matched visual words, e.g. 3, 100, 2000, etc. The system can use other values as well.

The system can also adjust the score based on how closely the visual words of the query and matched image are aligned, giving a higher score for visual words that are more closely aligned. In some implementations, the system assigns a value between 0 and 1 for each visual word based on the computed distance. The system can assign 1 to a perfectly aligned visual word, 0 to a visual word with a computed distance beyond the error threshold, and a proportional value between 0 and 1 for distances between 0 and the error threshold. In some implementations, the error threshold depends on the scale associated with the visual word, with visual words of larger regions having a larger error threshold than visual words of smaller regions.

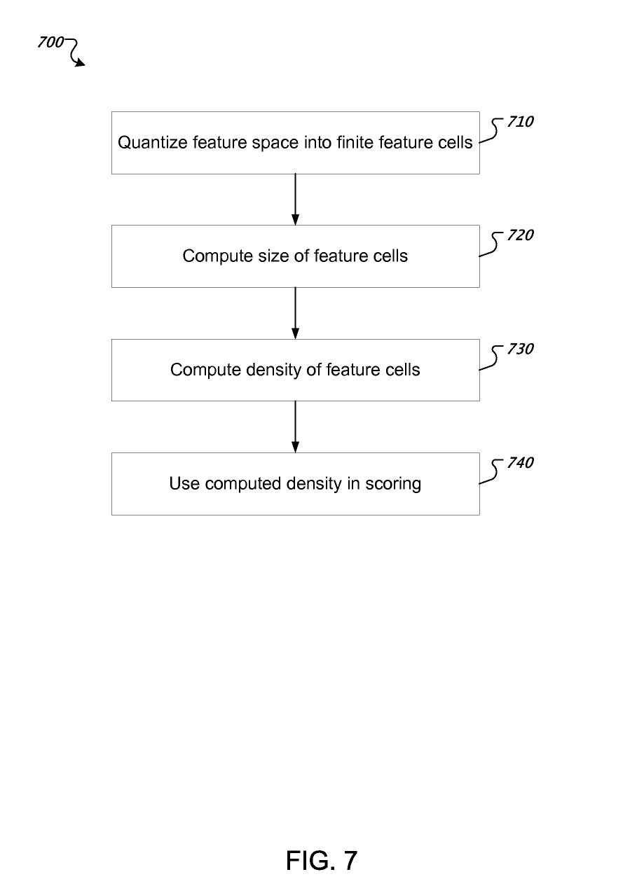

The system can further adjust the score by weighting the score for each visual word by a feature space density associated with the visual word. In other words, the system can multiply each visual word score by a value based on the feature space density of the visual word. Weighting based on feature space density is described in more detail below with reference to FIG. 7.

For example, query image 310 has three visual words, each having particular example coordinates in the image as follows:

A_{q}: (50, 100),

Q_{q}: (100, 200),

Y_{q}: (400, 90).

After traversing the posting lists, a matching image is encountered that has three visual words in common with the query image 310, each visual word having the following example coordinates:

Aₘ: (60, 100),

Qₘ: (116, 200),

Yₘ: (413, 90).

Because this geometry data is stored in the posting lists, the system can now compute a similarity score for the matched image using the geometry data. The system can search for a geometric mapping between the visual words of the query image 310 and the matched image, or:

(50, 100) to (60, 100),

(100, 200) to (116, 200),

(400, 90) to (413, 90).

Given an error threshold of 10 pixels, one possible mapping is a translation of 10 pixels along the first dimension. In other words, the parameters of the transformed coordinates would be a=1, b=10, c=1, d=0, resulting in transformed coordinates:

Aₜ: (60, 100),

Qₜ: (110, 200),

Yₜ: (410, 90).

The system can compute distances between the transformed coordinates and the coordinates of visual words of the matched image and assign scores based on the alignment of visual words. If the error threshold is 10 pixels and the matched image has 3 aligned visual words, the system can, for example, assign a score of 3. In contrast, if the error threshold is 5 pixels, the matched image has only two aligned visual words.

The computed distances can also affect the score for each aligned visual word. For example, visual word Aₘ can be said to be perfectly aligned with the transformed coordinates because the computed distance is zero. Thus, the system can assign a maximum score to visual word Aₘ, e.g., 1. The computed distance for visual word Qₘ is 6, and thus the system can assign a lower score to visual word Qₘ, e.g., 0.4, than to visual word Aₘ. If the error threshold were 5 pixels, the system could instead assign a score of 0 to visual word Qₘ.

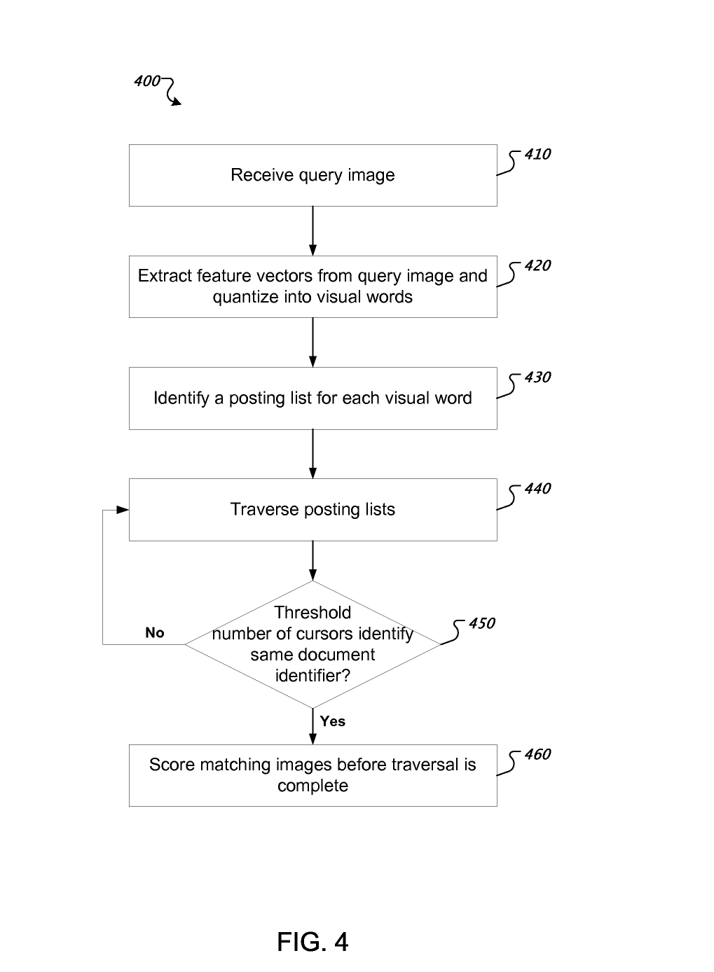

FIG. 4 is a flow chart of an example process 400 for scoring images by traversing multiple posting lists in parallel. The process 400 can be performed by a component of a search system, for example, indexing engine 242 or ranking engine 244 (FIG. 2), implemented as one or more computer programs installed on one or more computers in one or more locations. The process 400 will be described as being performed by an appropriately programmed system of one or more computers.

The system receives a query image (410). The query image can be uploaded to the system by a user device, or the system can retrieve the image from a specified resource locator, which may be received from a user device.

The system computes feature vectors from the query image and quantizes each of the feature vectors into one or more visual words (420). The system can train a quantizer that divides a particular feature space into a number of cells. In some implementations, if the feature space density of a particular feature vector is beyond a threshold, the query image is not assigned a visual word for the particular feature vector. Training of a quantizer and computation of feature space density will be described below in reference to FIG. 7.

The system identifies a posting list for each visual word (430). The system can maintain a separate posting list for each visual word, as described above in reference to FIG. 3.

The system traverses the posting lists to identify matching images (440). The system determines that an image is a matching image if the image has at least a threshold number of visual words in common with the query image, e.g. at least four visual words in common or at least ten visual words in common.

In some implementations, the system traverses multiple posting lists in parallel to identify matching images. The system can maintain, for each posting list, a respective current item on the posting list, maintained as a particular position on the posting list. The position of the current item can be maintained by a respective pointer, cursor, or other appropriate data structure.

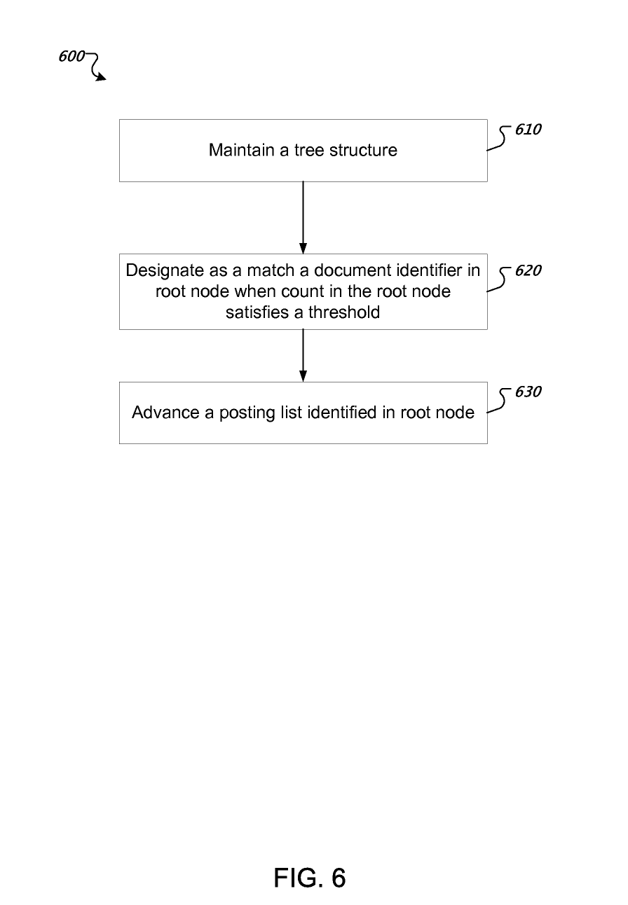

The system can traverse the posting listings by repeatedly choosing a posting list and advancing the chosen posting list from a current item to a subsequent item on the posting list. In some implementations, the system can use a tree structure to determine which of the multiple posting lists to advance, as described below in reference to FIG. 6.

The system determines whether a threshold number of current items identify a same document (450). After advancing a particular posting list, the system can count a number of current items with a same document identifier. If the count of current items with a same document identifier is greater than or equal to a minimum number of matching visual words, e.g. 4, the system can determine that the image corresponding to the document identifier is a matching image (branch to 460).

If the count of current items that identify a same document identifier is less than the minimum number of matching visual words, the system can continue to traverse the posting lists (branch to 440).

The system scores matching images before completing the traversal of the posting lists (460). After identifying a matching image, the system computes a score for the image before completing the traversal of the posting lists. The system can, for example, use geometry data stored in current posting list items to compute a score for the image. The system can thus identify and score matching images while traversing the posting lists no more than once.

In some implementations, the system computes a score for a matching image when matching images are detected and before further advancing any of the posting lists. However, the system can also score a matching image using associated geometry data in parallel with further traversal of the posting lists. After computing a score for a matching image, the system can output the image for ranking among other matching images during traversal or after traversal of the posting lists is complete.

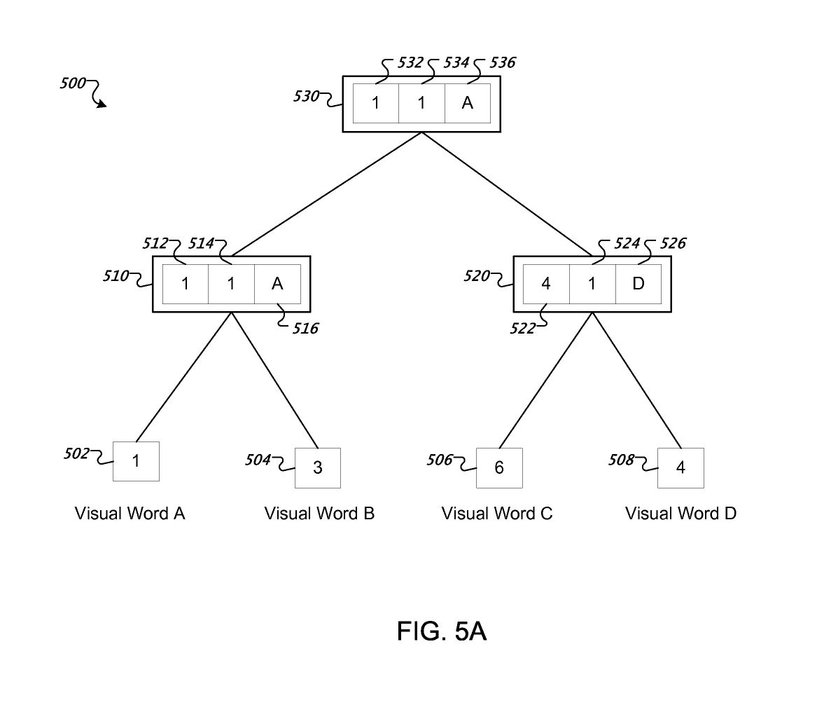

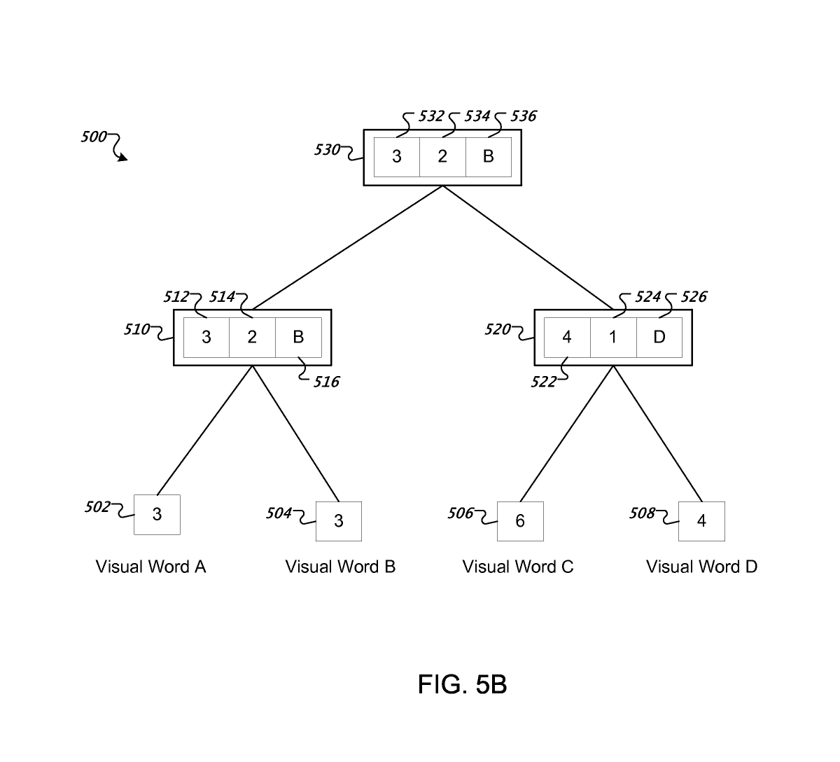

FIG. 5A is a diagram of an initial example tree structure 500 that can be used for determining which of multiple posting lists to advance. The tree structure 500 can be used in systems that use posting lists sorted by document identifier. After initializing or updating the tree structure 500, the root node of the tree structure indicates both (1) whether a matching image has been encountered and (2) which posting list to advance next. The system can then repeatedly advance the indicated posting list and update the tree structure 500 accordingly.

The tree structure 500 can be used to take advantage of “conditional move” instructions supported by particular data processors. The use of conditional moves can improve performance of the system by reducing the number of mispredicted branches taken by a processor during execution. The use of conditional moves to update the tree structure 500 will be described in more detail below.

Leaf nodes of the tree structure 500 correspond to posting lists being traversed. For example, leaf node 502 corresponds to the posting list for visual word A. The node itself includes or is associated with a document identifier indicated by a current cursor of posting list A, in this case document identifier “1”. Likewise, leaf node 504 corresponds to the posting list for visual word B and includes document identifier “3”. Leaf node 506 corresponds to posting list C and includes document identifier “6”. Leaf node 508 corresponds to posting list D and includes document identifier “15”.

While updating the tree structure, the system considers a “least-advanced” child node. A least-advanced child node of a parent node is a child node, from among all child nodes of the parent node, whose corresponding posting list has been traversed the least thus far. In the case that the posting lists are sorted by document identifiers and traversed from smallest document identifiers to largest document identifiers, the least-advanced child node can be identified by a document identifier that has the smallest value. The posting lists can similarly be traversed from largest document identifiers to smallest document identifiers, in which case the least-advanced child node will be identified by the child node of a parent node whose document identifier is the largest. The posting lists can be sorted in other ways as well, in which case the least-advanced child node can be determined according to respective positions of the child nodes on the posting lists being traversed.

Parent nodes in the tree structure include three elements of data: (1) a document identifier of a least-advanced child node, (2) a count of leaf nodes descendent from the parent node that include the document identifier of the least-advanced child node, and (3) a posting list identifier of a posting list of the least-advanced child node. For example, for parent node 510, the least-advanced child node is node 502 because node 502 identifies a document identifier, “1”, that is lower than the document identifier of node 504, “3”. Therefore, document identifier element 512 of the parent node 510 includes the document identifier “1” of the least-advanced child node. Count element 514 is a count of leaf nodes descendent from parent node 510 that identify the document identifier of the least-advanced child node. In this example, of leaf nodes descendent from parent node 510, only leaf node 502 identifies the document identifier of the least-advanced child node. Posting list element 516 of the parent node 510 identifies the posting list of the least-advanced child node. If multiple child nodes can be considered a least-advanced child node, the system can arbitrarily select from nodes that can be considered least-advanced child nodes for the third element.

Similarly, parent node 520 includes three elements of data (1) a document identifier of a least-advanced child node “4” 522, (2) a count “1” of leaf nodes descendent from the parent node that identify the document identifier of the least-advanced child node 524, and (3) a list identifier of a posting list “D” of the least-advanced child node 526.

The system can populate and update the root node 530 with information from its immediate children nodes, e.g., node 510 and node 520. Document identifier element 532, the least-advanced child of the root node, is populated with the smaller document identifier of the two children. Count element 534 is a sum of the counts in immediate child nodes that identify the document identifier of the root node's least-advanced child node. Posting list element 536 is a list identifier of the posting list of the root node's least-advanced child node. In the case that both immediate children identify the least-advanced child node, posting list element 536 can be populated with an arbitrary selection from posting lists identified by the two immediate children, e.g. posting list elements 516 and 526.

To determine which posting list to advance, the system needs only to look at the posting list identified by the root node 530 of the tree 500, e.g. posting list element 536.

To identify a matching image, the system needs only to look at the count of least-advanced child nodes in the root node 530 of the tree, e.g. count element 534. If the root node 530 of the tree is populated with a count of least-advanced child nodes that is greater than or equal to a minimum, e.g. four, the system determines that the document identifier of the least-advanced child node in the root node 530 of the tree, e.g. document identifier element 532, is a matching image.

To instantiate the tree structure, the system can assign visual words to a query image and populate leaf nodes of the tree structure with a first item on each posting list corresponding to each visual word. Parent nodes of the leaf nodes can then be populated according to document identifiers included in the leaf nodes. Matching images are indicated by a document identifier in the root node 530, e.g. document identifier element 532, when the count in the root node 530, e.g. count element 534, satisfies a threshold. The posting list to be advanced next is indicated by the posting list in the root node 530, e.g. posting list element 536.

When updating the tree structure 500 after advancing a particular posting list, the system can improve system performance by using conditional move instructions implemented in processor architectures as an alternative to branching instructions. When updating the tree structure 500, the system routinely determines whether a document identifier element of one node, e.g. document identifier element 512 of parent node 510, is less than, greater than, or equal to a document identifier element of another node, e.g. document identifier element 522 of parent node 520.

If the document identifier of parent node 510 is identifies a less advanced child than the document identifier of parent node 520, the document identifier element 532 of root node 530 will be populated with the document identifier of parent node 510. On the other hand, if the document identifier of parent node 510 is identifies a more advanced child than the document identifier of parent node 520, the document identifier element 532 of root node 530 will be populated with the document identifier of parent node 520. Either of these situations is equally likely, which can cause a processor that is maintaining tree structure 500 to be susceptible to frequently mispredicted execution branches. A third possible situation occurs if the document identifiers of nodes 510 and 520 are equal, in which case the system populates count element 534 of the root node with a sum of the parent nodes' count elements, e.g. 514 and 524. The system may not use conditional move instructions for the third situation. However, the third situation is expected to happen much less frequently.

In order to take advantage of conditional moves, the system can, for each parent node updated, generate a special “sum node,” whose elements are identical to a node arbitrarily selected from the two nodes being considered. However, the system will populate the count element of the “sum node” with a sum of count elements of the two nodes being considered. For example, if the system is updating root node 530 by considering parent nodes 510 and 520, the system can generate a “sum node” that contains elements from node 510, with the count element being a sum of count elements 514 and 524, a sum which would be “2” in this example.

The system can now update the root node by performing one or more branching-free conditional move instructions. If the document identifier element 512 is less than document identifier element 522, the values of node 510 are copied or moved into the root node. If the document identifier element 512 is greater than document identifier element 522, the values of node 520 are copied or moved into the root node. If document identifier element 512 is equal to document identifier element 522, the entire “sum node” is copied or moved into the root node. Thus, the tree structure 500 can be updated by a data processor using conditional move instructions, which can substantially reduce the number of mispredicted execution branches.

To minimize the number of conditional move instructions required to update a node, the system can pack the representation of each node into a particular number of bits. For example, if a conditional move instruction can move only 64 bits, the system can pack the node representation into 128 bits, which will require only two conditional moves. The system can, for example, use 64 bits for the document identifier, 32 bits for the least-advanced child count, and 32 bits for the posting list identifier. Alternatively, the system can pack the node representation into 64 bits, which will require only one conditional move instructions to update an internal node.

FIG. 5B is a diagram of an example tree structure 500 after advancing an example posting list corresponding to a leaf node as shown in FIG. 5A. The system advances the posting list corresponding to visual word “A” by advancing the cursor for the posting list from a first item on the list to a subsequent item. In this example, the next item on the posting list identifies document identifier “3”. Accordingly, the system can populate leaf node 502 with document identifier “3”.

The system updates parent node 510 by determining a least-advanced child node from among its child nodes. Because node 502 and node 504 both include the same document identifier “3”, the system determines that neither is less than the other and determines that the document identifier of the least-advanced child node is “3”. The system then updates the document identifier element 512 of node 510 to the determined least-advanced child node, which is document identifier “3”. The count of child nodes that identify document identifier “3” is now two, because both node 502 and node 504 identify the document identifier “3”. Therefore, the system updates count element 514 of node 510 to “2”. Because both child nodes of node 510 identify the same document identifier, the posting list element 516 of node 510 can be chosen arbitrarily from among posting lists corresponding to the child nodes. Thus, the system can populate posting list element 516 of parent node 510 with either “A” or “B”, and in this example, the system chooses “B”.

The system updates the root node 530 based on the update to parent node 510. The system compares document identifier element 512 “3” of parent node 510 to document identifier element 522 “4” of parent node 520. The system determines that the document identifier “3” is the document identifier of the least-advanced child node and updates document identifier element 532 of root node 530 with “3”. The count elements of intermediate child nodes that identify the least-advanced child node are then summed. In this example, only node 510 identifies the least-advanced child node, so the system updates count element 534 to two based on count element 514. The posting list element 536 identifying the posting list of the least-advanced child node is updated from parent node 510, resulting in posting list element 536 being updated to the posting list corresponding to visual word “B”.

Because the count in count element 534 is now two, the system can determine that the image of document identifier “3” has at least two visual words in common with the query image. If the matching threshold for common visual words is two, the system could compute a score for the image using geometry data stored in the posting lists as described above before further advancing any of the posting lists.

FIG. 6 is a flow chart of an example process 600 for traversing multiple posting lists using a tree structure to select which posting list to advance next. The process 600 will be described as being performed by an appropriately programmed system of one or more computers.

The system maintains a tree structure (610). As described above in reference to FIGS. 5A and 5B, leaves of the tree structure correspond to posting lists being traversed. The posting lists can correspond to visual words assigned to a query image. Each parent node of the tree structure includes (1) document identifier of a least-advanced child node, (2) a count of leaf nodes descendent from the parent node that include the document identifier of the least-advanced child node, and (3) a posting list identifier of a posting list of the least-advanced child node.

The system designates as a match a document identifier in a root node when a count of leaf nodes in the root node is at least a minimum value (620). After advancing a posting list and updating the tree structure accordingly, if the root node includes a count that is at least a minimum value, the system can designate the document identifier in the root node as a matching document. The system can determine that the document identifier indicates an image with a threshold number of matching visual words.

The system advances a posting list identified in the root node (630). The system next advances a posting list identified in the root node of the tree structure.

FIG. 7 is a flow chart of an example process 700 for computing a similarity score based on a feature cell density. As described above, feature vectors computed from images can be quantized into a predetermined number of feature cells, with each feature cell defining a visual word. Some visual words may be encountered by the system more often than others. Frequently-occurring visual words may not be as discriminative in determining image similarity as rarely-occurring visual words. Therefore, the system can improve the scoring of similar images by taking into consideration a computed feature cell density of feature vectors computed from images in a set of training images. The process 700 will be described as being performed by an appropriately programmed system of one or more computers.

The system quantizes a feature space into a finite number of feature cells (710). The system can quantize the feature space by determining clusters for a set of feature vectors as training samples, where each cluster defines a feature cell.

The system can initially cluster the training samples into a number of clusters, and then iteratively determine local subclusters of each cluster until a target number of clusters, i.e. feature cells, is reached. The system can use any appropriate clustering algorithm, e.g. k-means, to determine the clusters and can use any appropriate distance metric, e.g. the L² distance, when assigning a training sample to a nearest cluster.

The system can initialize the clustering process by randomly or pseudorandomly selecting a relatively small number of training samples, e.g. 200, from the larger set of training samples as candidate cluster centers. The system can then assign all training samples to a nearest candidate cluster center. At each iteration, the system can increase the number of clusters by performing a clustering algorithm locally only on feature vectors assigned to a cluster. In other words, a particular cluster can be further locally clustered into a number of subclusters, e.g., four subclusters. On iteration k+1, the system can determine a target number of clusters Cₖ₊₁ by:

Cₖ₊₁=4Cₖ,

where Cₖ is the number of clusters on iteration k. The system can maintain a more uniform distribution of training samples in each feature cell by assigning substantially the same number of training samples to each cluster on each iteration. Thus, on iteration k+1, the target number of training samples for each feature cell Sₖ₊₁ can be given by:

$${S}_{k + 1} = \frac{N}{{C}_{k + 1}} ,$$

where N is the total number of training samples and Cₖ₊₁ is the target number of clusters on iteration k+1.

The system computes a size of each feature cell by measuring an average distance between the cell center and training samples assigned to the cell (720). The system can first calculate a center point of each cell and then compute a distance between the computed center and each training example assigned to the cell. The distance can be measured by any appropriate metric between vectors, e.g., the L² distance. The computed distances within each cell can be used to compute a size of the cell. For example, the size can be computed as an arithmetic mean of the computed distances from training examples in a cell to the cell center.

The system computes a density of each feature cell (730). The system can compute a density of each feature cell by dividing the computed cell size by the number of training examples assigned to the cell.

The system uses the computed density in scoring (740). The system can compute a weight for each feature cell based on the density, with higher-density feature cells having a lower weight than low-density feature cells. In some implementations, a number of highest-density feature cells are assigned a weight of zero.

The weight Wᵢ assigned to a feature cell i can be computed by:

Wᵢ=e^{0.5*(1-2d}^{ᵢ}^{/D)},

where dᵢ is the density of feature cell i and D is a threshold density.

The system can then use the computed weight for a feature cell when computing a similarity score with a visual word corresponding to that feature cell. For example, after determining the alignment of a matched visual word with transformed coordinates as described above, the system can weight the resulting score by the computed weight Wᵢ for the visual word. If the feature space of a visual word has a high density, e.g. above threshold density D, the system can disregard the visual word altogether during scoring. In other words, the system does not compute transformed coordinates for the visual word and instead considers only visual words with lower feature space densities.

The system can also use the feature space densities to select a subset of visual words for a query image. After computing visual words for a query image, the system can select only a subset of the computed visual words to be used for traversing corresponding posting lists. In some implementations, the system can select visual words with lower feature space densities and omit visual words with higher feature space densities. For example, if a particular query image has 200 computed visual words, the system can select only the 100 visual words with the lowest-density feature spaces as the visual words that will be used to traverse the posting lists.

The system can also use feature space densities when indexing images in posting lists. Because the posting lists are indexed by visual word, the system can also associate the computed weight for a feature cell with each item on the corresponding visual word posting list. Thus, for a number of highest-density visual words, e.g. with densities above threshold density D, the system can omit creating a posting list for these visual words altogether. Omitting high-density words from indexing further saves the system the cost of storing and traversing high-density posting lists.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method for computing a score for an image by traversing multiple posting lists in parallel comprising:
receiving a query image;
determining a plurality of visual words from the query image;
identifying multiple posting lists for the plurality of visual words, including identifying a respective posting list for each of the visual words from the query image, each posting list comprising respective items that each identify an indexed image that has the visual word corresponding to the posting list, wherein each item of a particular posting list is associated with geometry data for a corresponding particular visual word from an indexed image identified by the item, and wherein each of the posting lists has a respective item cursor that designates a current posting list item in the posting list;
advancing a particular item cursor for one of the multiple posting lists by updating the item cursor of a particular posting list from designating a first item in the particular posting list to designating a subsequent item in the particular posting list;
determining a count of item cursors designating posting list items that identify a same particular indexed image, wherein the count of item cursors represents a number of visual words from the indexed image that match visual words from the query image;
determining that the count of item cursors designating posting list items that identify a same particular indexed image satisfies a threshold;
in response to determining that the count of item cursors designating items that identify a same particular indexed image satisfies a threshold, identifying geometry data associated with the items that identify the same particular indexed image, wherein the geometry data is geometry data for visual words from the particular indexed image;
computing a score for the particular indexed image before advancing to an end of the particular posting list, including comparing the visual words from the query image to the visual words from the particular indexed image using the geometry data associated with the items that identify the same particular indexed image; and
ranking the particular indexed image relative to one or more other images using the computed score.

2. The method of claim 1, wherein computing a score for the particular indexed image comprises computing a score for the particular indexed image before further advancing any item cursors for the posting lists.

3. The method of claim 1, wherein computing a score for the particular indexed image comprises computing a score for the particular indexed image before advancing to the end of any of the posting lists.

4. The method of claim 1, wherein advancing a particular posting list of the posting lists comprises:
advancing an item cursor of a posting list identified by a root node of a tree structure for the posting lists being traversed, wherein each leaf node of the tree structure corresponds to a posting list being traversed and includes a document identifier of a document identified by an item in the corresponding posting list, wherein items in each posting list are sorted by document identifier; and
updating a leaf node corresponding to the particular posting list with a first document identifier of a first document identified by the subsequent item in the particular posting list.

5. The method of claim 4, further comprising:
updating, for each particular parent node ascendant from the leaf node corresponding to the particular posting list, (1) a least-advanced document identifier among document identifiers of leaf nodes descendent from the particular parent node, a count of leaf nodes descendent from the particular parent node that identify the least-advanced document identifier, and (3) a list identifier of a posting list having a leaf node associated with the least-advanced document identifier.

6. The method of claim 1, further comprising weighting the computed score by a weight based on a computed feature space density of a feature cell for the corresponding visual word.

7. The method of claim 5, wherein updating each particular parent node comprises updating the parent node using at least one conditional move instruction.

8. The method of claim 7, wherein updating the parent node using at least one conditional move instruction comprises:
generating a sum node with elements of a child node of two or more child nodes of the parent node being updated, wherein a count element of the sum node is a sum of count elements of the two or more child nodes of the parent node that is being updated;
determining that the image identifier of a first child node of the two or more child nodes is less than an image identifier of a second child node of the two or more child nodes; and
moving, using the conditional move instruction, the contents of the first child node into the parent node.

9. The method of claim 7, wherein updating the parent node using at least one conditional move instruction comprises:
generating a sum node with elements of a child node of two or more child nodes of the parent node being updated, wherein a count element of the sum node is a sum of count elements of the two or more child nodes of the parent node that is being updated;
determining whether the image identifier of a first child node of the two or more child nodes is equal to an image identifier of a second child node of the one or more child nodes; and
moving, using the conditional move instruction, the contents of the sum node into the parent node.

10. The method of claim 6, further comprising:
computing the feature space density of the feature cell including:
quantizing each of a plurality of feature vectors into a corresponding feature cell; and
computing a size of each feature cell, wherein the feature space density is based at least in part on dividing a number of feature vectors quantized to the feature cell by the computed size of the feature cell.

11. The method of claim 10, wherein computing a size of each feature cell comprises computing respective distances between a cell center and feature vectors quantized to the feature cell.

12. A computer-implemented method comprising:
receiving a query image;
computing multiple feature vectors from the query image and quantizing each feature vector into one or more respective visual words;
identifying multiple posting lists, one posting list for each computed visual word, wherein each posting list is a list of items having document identifiers for respective images that are assigned a same visual word, wherein each of the multiple posting lists is associated with a respective cursor, wherein each cursor identifies an item on a corresponding posting list, wherein each item on the posting list is associated with geometry data for a visual word computed from an image identified by the document identifier of the item;
traversing the multiple posting lists by repeatedly:
selecting one of the cursors as a current cursor;
advancing a posting list of the current cursor by updating the cursor to identify a subsequent item on the posting list of the current cursor;
determining a count of cursors of the multiple posting lists that identify a same particular document identifier;
determining whether the count of cursors that identify the same particular document identifier satisfies a threshold;
computing a score for an image corresponding to the particular document identifier if the count of cursors that identify the same particular document identifier satisfies a threshold, wherein the score is based at least in part on the geometry data associated with posting list items that identify the particular document identifier, and wherein the score is computed before advancing to an end of the posting list of the current cursor; and
ranking the image corresponding to the same document identifier relative to one or more other images by respective computed scores.

13. A system comprising:
one or more computers and one or more storage devices storing instructions that are operable, when executed by the one or more computers, to cause the one or more computers to perform operations comprising:
receiving a query image;
determining a plurality of visual words from the query image;
identifying multiple posting lists for the plurality of visual words, including identifying a respective posting list for each of the visual words from the query image, each posting list comprising respective items that each identify an indexed image that has the visual word corresponding to the posting list, wherein each item of a particular posting list is associated with geometry data for a corresponding particular visual word from an indexed image identified by the item, and wherein each of the posting lists has a respective item cursor that designates a current posting list item in the posting list;
advancing a particular item cursor for one of the multiple posting lists by updating the item cursor of a particular posting list from designating a first item in the particular posting list to designating a subsequent item in the particular posting list;
determining a count of item cursors designating posting list items that identify a same particular indexed image, wherein the count of item cursors represents a number of visual words from the indexed image that match visual words from the query image;
determining that the count of item cursors designating posting list items that identify a same particular indexed image satisfies a threshold;
in response to determining that the count of item cursors designating items that identify a same particular indexed image satisfies a threshold, identifying geometry data associated with the items that identify the same particular indexed image, wherein the geometry data is geometry data for visual words from the particular indexed image;
computing a score for the particular indexed image before advancing to an end of the particular posting list, including comparing the visual words from the query image to the visual words from the particular indexed image using the geometry data associated with the items that identify the same particular indexed image; and
ranking the particular indexed image relative to one or more other images using the computed score.

14. The system of claim 13, wherein computing a score for the particular indexed image comprises computing a score for the particular indexed image before further advancing any item cursors for the posting lists.

15. The system of claim 13, wherein computing a score for the particular indexed image comprises computing a score for the particular indexed image before advancing to the end of any of the posting lists.

16. The system of claim 13, wherein advancing a particular posting list of the posting lists comprises:
advancing an item cursor of a posting list identified by a root node of a tree structure for the posting lists being traversed, wherein each leaf node of the tree structure corresponds to a posting list being traversed and includes a document identifier of a document identified by an item in the corresponding posting list, wherein items in each posting list are sorted by document identifier; and
updating a leaf node corresponding to the particular posting list with a first document identifier of a first document identified by the subsequent item in the particular posting list.

17. The system of claim 16, wherein the operations further comprise
updating, for each particular parent node ascendant from the leaf node corresponding to the particular posting list, (1) a least-advanced document identifier among document identifiers of leaf nodes descendent from the particular parent node, a count of leaf nodes descendent from the particular parent node that identify the least-advanced document identifier, and (3) a list identifier of a posting list having a leaf node associated with the least-advanced document identifier.

18. The system of claim 13, wherein the operations further comprise weighting the computed score by a weight based on a computed feature space density of a feature cell for the corresponding visual word.

19. The system of claim 17, wherein updating each particular parent node comprises updating the parent node using at least one conditional move instruction.

20. A computer program product, encoded on one or more non-transitory computer storage media, comprising instructions that when executed by one or more computers cause the one or more computers to perform operations comprising:
receiving a query image;
determining a plurality of visual words from the query image;
identifying multiple posting lists for the plurality of visual words, including identifying a respective posting list for each of the visual words from the query image, each posting list comprising respective items that each identify an indexed image that has the visual word corresponding to the posting list, wherein each item of a particular posting list is associated with geometry data for a corresponding particular visual word from an indexed image identified by the item, and wherein each of the posting lists has a respective item cursor that designates a current posting list item in the posting list;
advancing a particular item cursor for one of the multiple posting lists by updating the item cursor of a particular posting list from designating a first item in the particular posting list to designating a subsequent item in the particular posting list;
determining a count of item cursors designating posting list items that identify a same particular indexed image, wherein the count of item cursors represents a number of visual words from the indexed image that match visual words from the query image;
determining that the count of item cursors designating posting list items that identify a same particular indexed image satisfies a threshold;
in response to determining that the count of item cursors designating items that identify a same particular indexed image satisfies a threshold, identifying geometry data associated with the items that identify the same particular indexed image, wherein the geometry data is geometry data for visual words from the particular indexed image;
computing a score for the particular indexed image before advancing to an end of the particular posting list, including comparing the visual words from the query image to the visual words from the particular indexed image using the geometry data associated with the items that identify the same particular indexed image; and
ranking the particular indexed image relative to one or more other images using the computed score.
